(19) United States
(12) Patent Application Publication
(10) Pub. No.: US 2007/0005681 A1
(43) Pub. Date: Jan. 4, 2007

(54) Method and system for supporting business system development

(75) Inventors: Masaya Shozui, Musashino (JP); Tomokazu Ubukata, Kawasaki (JP); Toyomitsu Yoneda, Tokyo (JP); Kazuyuki Aoyama, Akishima (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/282,449

(22) Filed: Nov. 17, 2005

(30) Foreign Application Priority Data
Mar. 30, 2005 (JP) 2005-096699

(51) Int. Cl. G06F 15/16

(52) U.S. Cl. 709/201

(57) ABSTRACT

A content reuse type system configuration supporting system is provided which can configure a business system realizing customer business requirements by accumulating legacy work system configuration examples, inter-system link processing methods, and specification information on legacy customer work systems. An order reception system, i.e., a development side, stores work system specifications presently used by an order system, i.e., a customer side, past system configuration examples, and inter-system link methods. When a new customer business system is to be configured, a target system selection apparatus searches work systems and a link method for the work systems satisfying a requested specification, i.e., work requirements, of the order system, to thereby configure the business system.

### INCORPORATION BY REFERENCE

The present application claims priority from Japanese application JP 2005-096699 filed on Mar. 30, 2005, the content of which is hereby incorporated by reference into this application.

### BACKGROUND OF THE INVENTION

The present invention relates to a method and system for supporting business system development, and more particularly to a method and system for configuring a business system by searching examples of pre-registered system configurations, work packages and software components and utilizing the searched examples to configure the business system.

A customer business system is developed by arranging system requirements of each customer. In developing a customer business system, neither the whole system is newly created nor the business system is configured by customizing work packages. The business system is developed on the basis of accumulated other business system configuration examples, while positively utilizing the legacy work system resources presently used by a customer.

As an approach to newly configuring a system by customizing information on design on a reuse assumption, JP-A-2002-358200 discloses a system in which components created on a reuse assumption, such as common basic middlewear and framework of each business, are designed beforehand and the components are properly combined to form software which has a high reuse factor and is easy to be customized.

### SUMMARY OF THE INVENTION

JP-A-2002-358200 assumes that system components are accumulated and used on the assumption of reuse of each component. There is a system which aims at an individual work system such as a work package and does not aim at a whole business system (a set of work systems) used by a customer. Design works are not made for linking individual systems after configuring the systems. In order to solve this, the following approach is desired. Namely, customer work systems constituting core competence in a legacy customer system are provided with other work systems from a vendor. The customer work systems and other work systems are add-on customized to satisfy the requirements of a new costumer business network and configure work systems realizing core competence. In this manner, the legacy work systems themselves realizing core competence can be reused.

It is desired that not only software and components on the reuse assumption are configured but also system components and work packages not on the reuse assumption are combined. In terms of a customer business system creating software components, reuse is assumed only by components of a small granularity. For development of a business system requested by a customer, it is necessary to combine component groups of a small granularity, configure a plurality of work systems and combine the work systems. Therefore, a load on a system engineer increases, including integrity, verification and design documents of reused software components, design of a business system and the like. Furthermore, the legacy work systems presently used and constituting core competence of customer business are not considered, and reused components are used for new core competence so that a load on a system engineer increases.

An object of the present invention is to provide a business system configuration supporting method and system which applies a legacy business system as customer core competence to a new business system configuration.

In order to achieve the above-described object of the invention, legacy system resources of an order system are analyzed and the analysis information is stored, and system configuration examples already accumulated by an order reception system are stored. According to these information, the structure is adopted searching work systems constituting a business system which satisfies a specification requested by the order system.

### BRIEF DESCRIPTION OF THE DRAWINGS

FIG. 1 is a diagram showing the structure of a business system according to an embodiment of the present invention.

FIG. 2 is a diagram showing systems using the business system of the embodiment.

FIG. 3 is a diagram illustrating process sequences of each system of the embodiment.

FIG. 4 is a diagram showing the detailed structure of the business system shown in FIG. 1.

FIG. 5 shows an example of information stored in a legacy business system analysis information storage apparatus 0408.

FIG. 6 is a flow chart illustrating a legacy business system analysis storage process.

FIG. 7 shows an example of information stored in a system configuration example storage apparatus 0410.

FIG. 8 is a flow chart illustrating a system configuration example information storage process.

FIG. 9 shows an example of a display screen displaying information managed by a target system selection apparatus 0130.

FIG. 10 shows an example of a display screen for displaying and selecting link information between work systems and the display screen referenced from the target system selection apparatus.

FIG. 11 is a flow chart illustrating a selection process for an example satisfying the requirements of a new customer business system.

### DETAILED DESCRIPTION OF THE INVENTION

An embodiment of the present invention will be described in detail with reference to the accompanying drawings. The invention is not limited only to the embodiment.

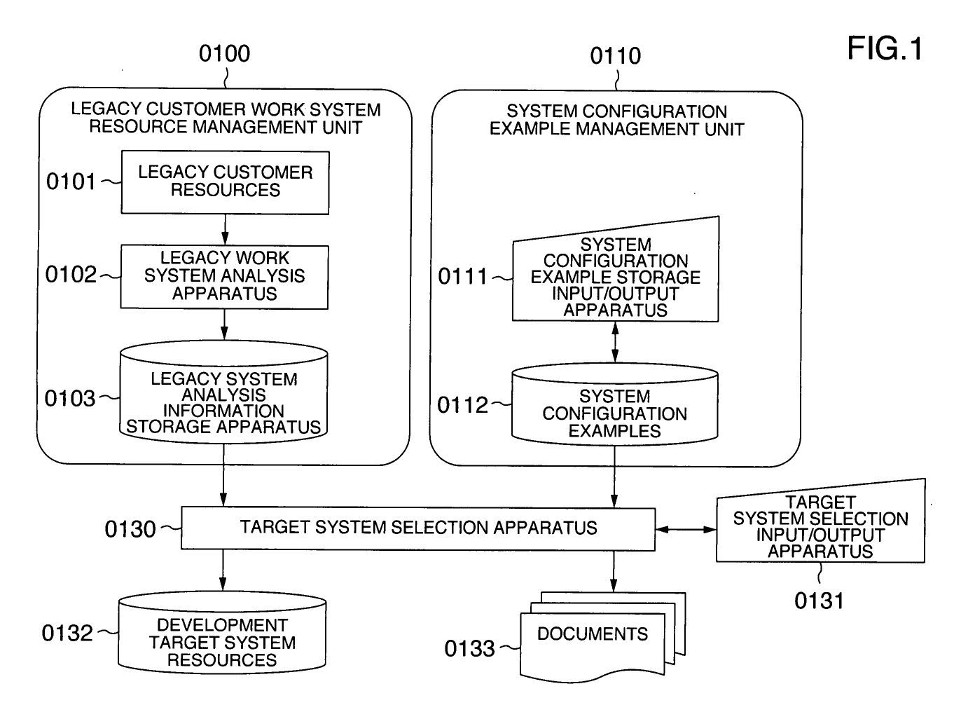

FIG. 1 shows an example of the structure of a business system development supporting system according to the embodiment of the invention. This system is constituted of: a legacy customer business resource management unit 0100 for managing legacy customer business system specification information; a system configuration example management unit 0110 for managing work packages (ERP packages: Enterprise Resource Planning), and specifications and configuration examples of business software components; and a target system selection apparatus 0130 for selecting a new costumer business system. A selected new customer business system is stored in a development target system resource (program, execution environment, environment setting information) storage unit 0132. The business system is constituted of a plurality of work systems and includes a set of information systems used by an enterprise for performing sales, production, delivery and the like.

In order to deal with a change in the state of system configuration, normally operating work systems and legacy customer resources are shifted from design information at the time of system configuration, and do not coincide with the design information generated by collecting work specifications at the start of system configuration. Therefore, in the legacy costumer work system resource management unit 0100, a legacy work system analysis apparatus 0102 analyzes legacy customer resources (programs, execution environments, environment setting information) 0101 operating at a customer to create the specifications of the legacy customer work system. The analyzed results are stored in a legacy work system analysis information storage apparatus 0103 and managed therein.

In the system configuration example management unit 0110, a system configuration example storage information input/output apparatus 0111 inputs/outputs: work system configuration examples or specifications of work packages executed in the past by system configuration vendors and the like; service specifications and configuration examples provided by an outsourcing company called an application service provider; and specifications and configuration examples of work application components used when a work system is configured. The system configuration example input from the system configuration example storage information input/output apparatus 0111 is stored in a system configuration example information storage apparatus 0112. The work system is an information system used by an enterprise to make business, for example, a sales management system.

The target system selection apparatus 0130 collects the legacy customer work system specifications stored in the legacy work system analysis information storage apparatus 0103 and work system configuration examples accumulated by a system configuration vendor and stored in the system configuration example information storage apparatus 0112, and outputs the collected specifications and examples to a target system selection input/output apparatus 0131. The target system selection input/output apparatus 0131 transmits business system information and the like selected by a user to the target system selection apparatus 0130. In accordance with the received information, the target system selection apparatus 0130 creates business system configuration information and stores it in the development target system resource storage unit 0132. The target system selection apparatus 0130 links the legacy work system information, system configuration examples and work systems, respectively selected by a user at the target system selection input/output apparatus 0131, selects a processing method design example for linking a plurality of work systems, and outputs, as design documents 0133, design information for a target development system document creation unit to configure the business system.

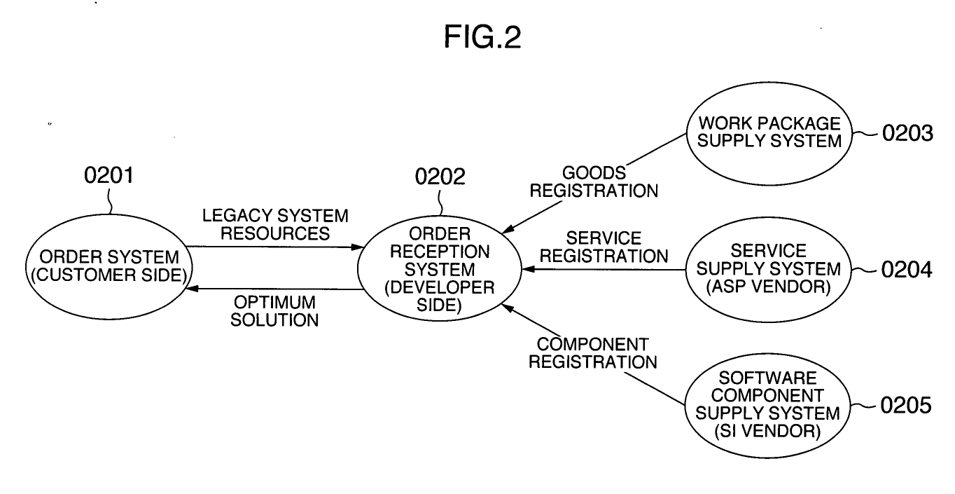

FIG. 2 is a diagram illustrating the relation of users of a development system for a content reuse type system of the embodiment. On the side of an order system (customer side) 0201 for asking system development, modification of the system becomes necessary if the legacy business system or legacy work systems cannot absorb business innovation. Therefore, the order system 0201 asks an order reception system (developer side) 0202 receiving system development, about business system configuration. The order reception system 0202 confirms system requirements of the order system 0201, selects work packages and legacy customer work system resources best matching the system requirements of the order system 0201, from a work package supply system 0203, a service supply system 0204 for supplying services such as lending an application in time charge, and a software component supply system 0205, and supplies the order system 0201 with the packages and resources as an optimum solution. The optimum solution means a business system satisfying the requirements of a new business system by the order system (customer side) 0201.

The work package supply system 0203 registers business package specifications and goods information in the order system 0202. The order system 0202 refers to the registered specifications and information to select an optimum solution. The service supply system 0204 registers outsourcing service supply contents such as outsourcing services, user scales, fee systems to be supplied by the service supply system 0204, and use example information, in the order system 0202. As the service supply system 0204, an Application Service Provider (ASP) capable of providing application features via a network can be used. The order system 0202 searches the registered services and various information to select an optimum solution. The software component supply system 0205 registers software components and link components (e.g., software for executing file transfer and a component for absorbing a difference between character codes) information for lining systems, in the order system 0202. As the software component supply system 0205, a System Integrator (SI) can be used. The order system 0202 searches the registered components and information to select an optimum solution.

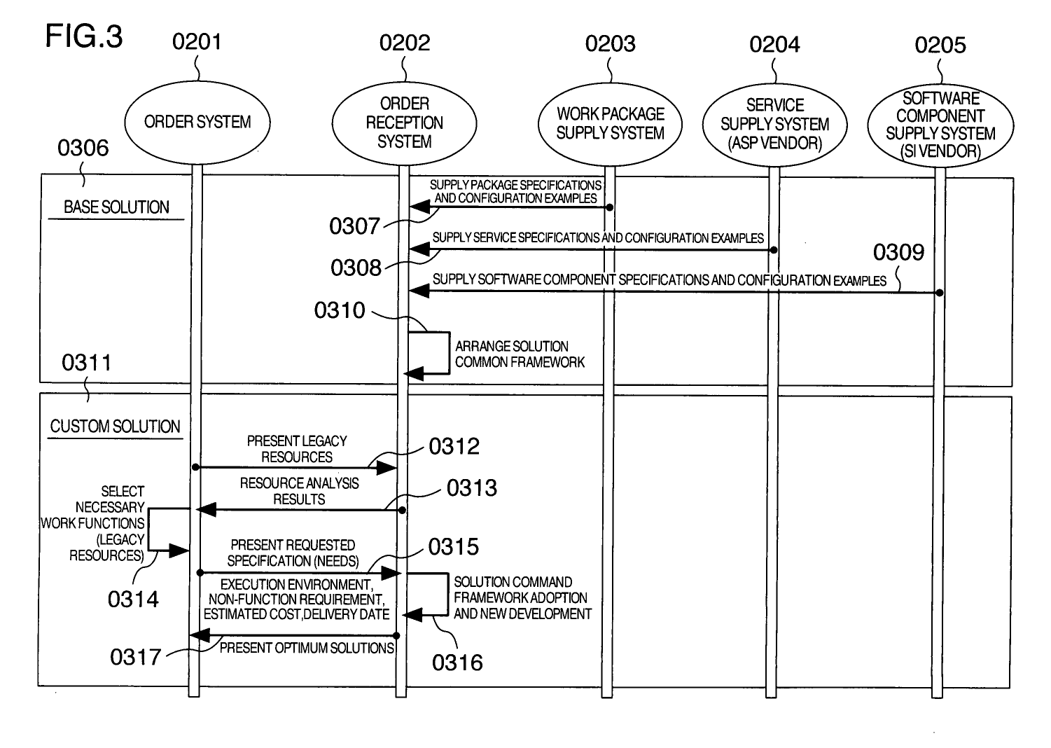

FIG. 3 is a diagram showing a flow of information when the order reception system 0202 supplies an optimum solution to the order system 0201 according to the invention. Steps 0307 to 0310 illustrate a process of developing a general base solution 0306, to be executed by the order reception system 0202, and Steps 0312 to 0317 illustrate a process of developing a custom solution 0311, to be executed by the order reception system 0202.

First, detailed description will be made on the process of creating a base solution 0306. The work package supply system 0203 supplies the order reception system 0202 with the work package configuration examples and work package specifications (Step 0307). Next, the service supply system 0204 supplies the order reception system 0202 with the contents of outsourcing services and use examples (Step 0308). Next, the software component supply system 0305 supplies the order reception system 0202 with software component specifications and configuration example information (Step 0309). Lastly, the order reception system 0202 arranges the system configuration examples and each product specification supplied from the work package supply system 0203 and the like in a common arrangement frame (Step 0310).

Next, detailed description will be made on the process of creating the custom solution 0311. The order reception system 0202 creates the custom solution 0311 which is a solution (work system group) optimized for a customer, by customizing the legacy work systems and information supplied from the work package supply system 0203 and the like, in accordance with the system requirements requested by the order system 0201, and supplies an optimum solution to the order system 0201. Namely, a solution is reduced in practice and supplied as resources when the business system is to be configured.

In the process of creating the custom solution 0311, first the order system 0202 receives the legacy work system resources from the order system 0201 (Step 0312). The order reception system 0202 received the legacy work system resources analyzes the resources and presents the analysis results to the order system 0201 (Step 0313). Considering the analysis results, the order system 0201 selects the resources which are left as legacy customer work system resources (Step 0314). More specifically, the order system 0201 selects work logics which become core competence adopted by the new business system, from the legacy work system analysis results supplied from the order reception system 0202.

Next, the order system 0201 explicitly presents the work logics as core competence and supplies the work logics as a requested specification (Step 0315). Namely, the order reception system 0202 receives from the order system 0201 the legacy work system resources selected as core competence, requirements to be newly formed, execution environments, an estimated cost and the like. The order reception system 0202 received the requested specification from the order system 0201 refers to information stored as the general base solution 0306, selects work systems constituted of the legacy work system resources, work packages and the like satisfying the requested specification of the order system 0201, and presents custom business system candidates to the order system 0201 to select the candidate most matching the requested specification (Step 0316). The order reception system 0202 creates several most suitable solutions and presents the solutions to the order system 0201 to urge selection (Step 0317).

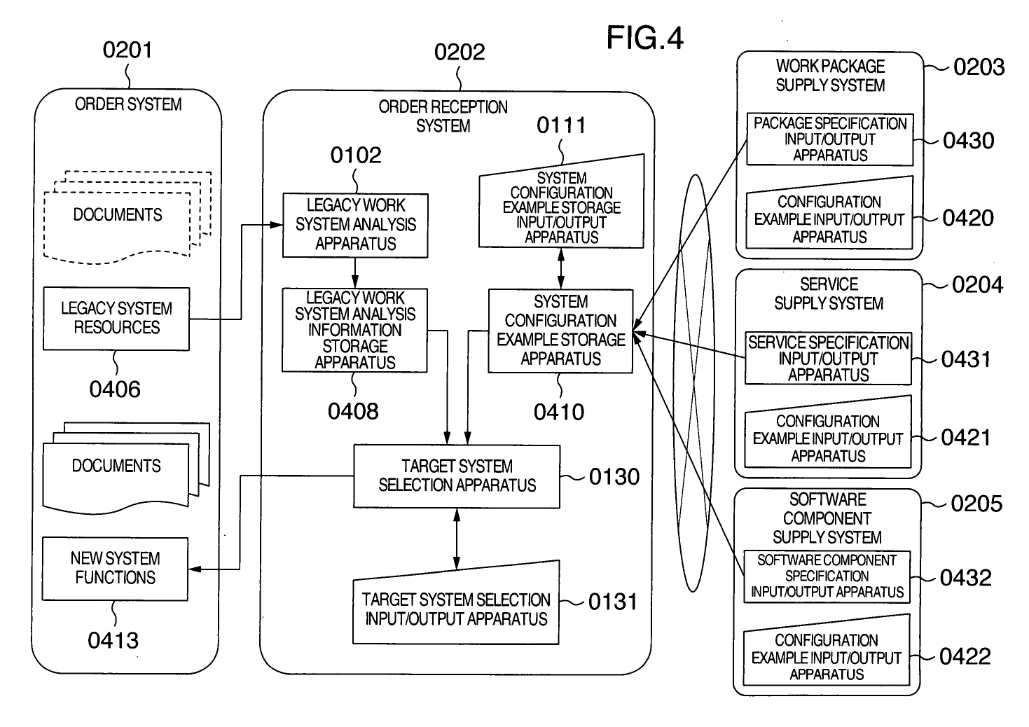

FIG. 4 is a diagram illustrating how the development system of the content reuse type system of the embodiment is used. The order system 0201 supplies the legacy work system resources 0406 to the order reception system 0202. The legacy work system analysis apparatus 0102 of the order system 0202 analyzes the supplied legacy custom work system resources 0406 and stores, as specification information, the analysis results in a legacy work system analysis information storage apparatus 0408.

The system configuration example input/output apparatus 0111 receives system configuration examples configured in the past by the order reception system 0202 itself and stores the received information in a system configuration example storage apparatus 0410. Similarly, in the work package supply system 0203, a configuration example input/output apparatus 0420 receives work package specifications, and a package specification input/output apparatus 0430 transmits input specifications to the system configuration example storage apparatus 0410 of the order reception system 0202. In the service supply system 0204, a configuration example input/output apparatus 0421 receives service specifications, and a service specification input/output apparatus 0431 transmits input specifications to the system configuration example storage apparatus 0410 of the order reception system 0202. In the software component supply system 0205, a configuration example input/output apparatus 0422 receives software specifications, and a software component specification input/output apparatus 0432 transmits input specifications to the system configuration example storage apparatus 0410 of the order reception system 0202. The system configuration example storage apparatus 0410 of the order reception system 0202 stores the specifications transmitted from the supply systems.

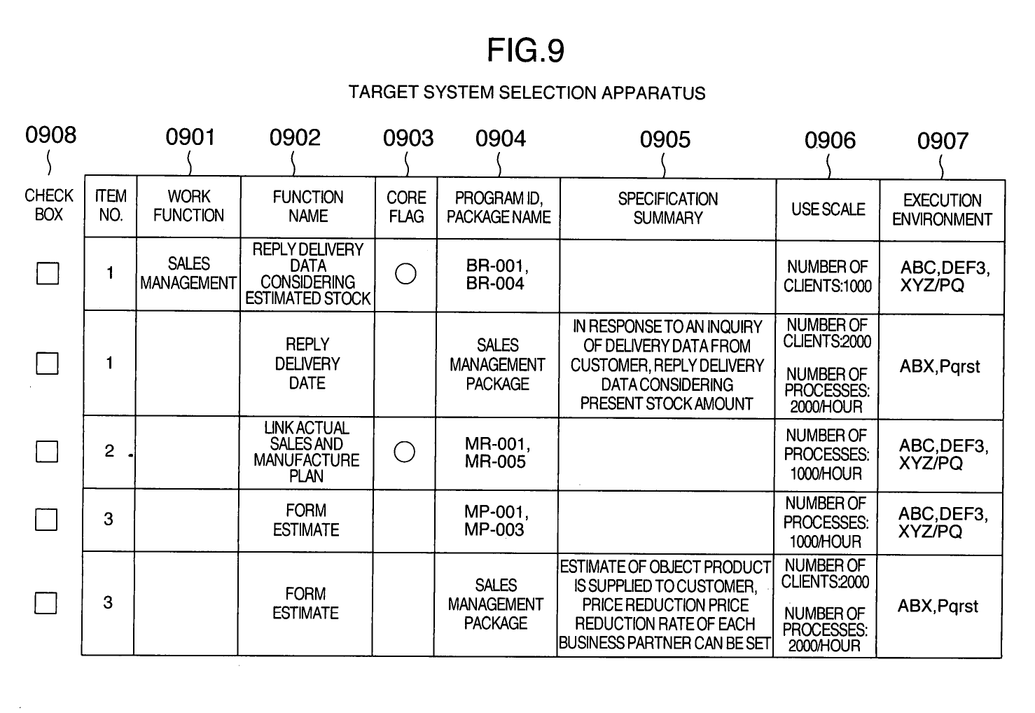

Next, in accordance with such transmitted and stored specifications, the target system selection apparatus 0130 selects new work systems and a link method of linking the work systems, from the information stored in the legacy work system analysis information storage apparatus 0408 and system configuration example storage apparatus 0410 to configure the business system and integrally manage the legacy work system information and system configuration examples by using the work names and function summaries, as shown in FIG. 9. When the new business system is configured in accordance with the information integrally managed in the target system selection apparatus 0130, the order reception system 0202 receives the legacy work system specifications and system configuration examples to be continuously used by the legacy work systems and selected by the target system selection input/output apparatus 0131, in accordance with the information stored in the legacy work system analysis information storage apparatus 0408 and system configuration example storage apparatus 0410. The new work systems and the link method of linking the work systems selected by the target system selection input/output apparatus 0131 are combined, and new system functions and resources 0413 of the new business system is supplied to the order system 0201.

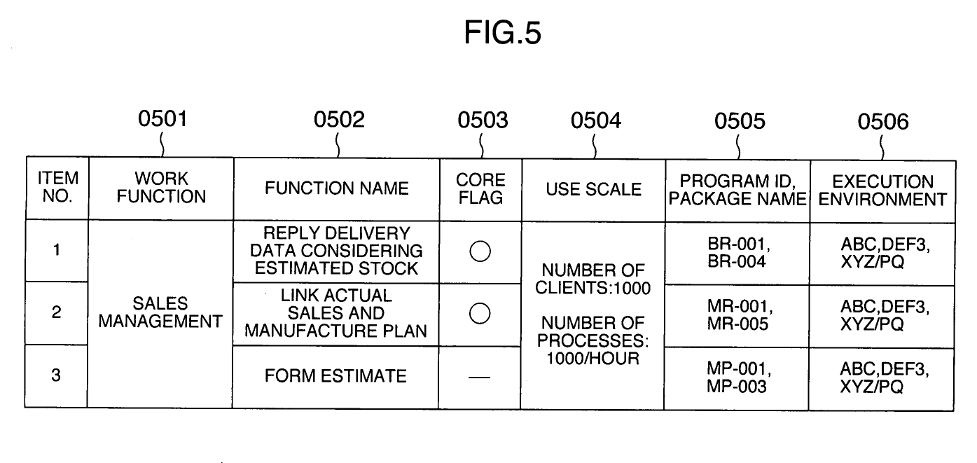

FIG. 5 shows an example of a storage layout of the legacy work system analysis information storage apparatus 0408 shown in FIG. 4. The legacy work system analysis information storage apparatus stores program IDs and work package names 0505 and execution environments 0506 respectively corresponding to the legacy work system resources 0406. It also stores work function names 0501, function names 0502 and use scales 0504, respectively corresponding to work system design specifications. If the order system 0201 received the analysis results from the order reception system 0202 desires to continuously use the legacy work systems in a new system, i.e., if the legacy work system has the work functions (i.e., work functions as the core of the legacy system) constituting core competence, a circle symbol is affixed to a core flag 0503 which is set by the order system 0202 to notify the order reception system 0202 of that the function is included in the requested specification when a new business system is configured.

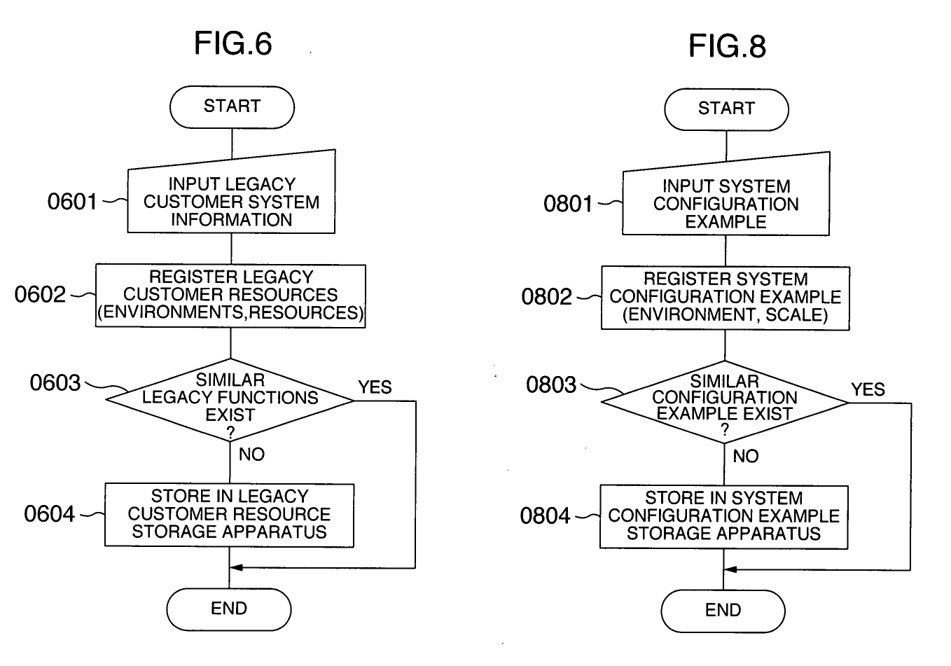

FIG. 6 is a flow chart illustrating a process of registering analysis results of the legacy custom work systems in the legacy system analysis information storage apparatus 0408, to be executed by the legacy work system analysis apparatus 0102. The legacy work system analysis apparatus 0102 first receives legacy custom work system information (Step 0601) from the legacy work system analysis apparatus 0102. Next, the input legacy work system information is registered (Step 0602). In this case, it is judged whether similar functions are already registered (Step 0603), and if the similar function is not registered (Step 0603: NO), the analysis result information is stored in the legacy system analysis information storage apparatus 0408 (Step 0604). Namely, duplicated storage is avoided. If it is judged at Step 0603 that a duplicated function exists, this work system is not stored in the legacy system analysis information storage apparatus 0408.

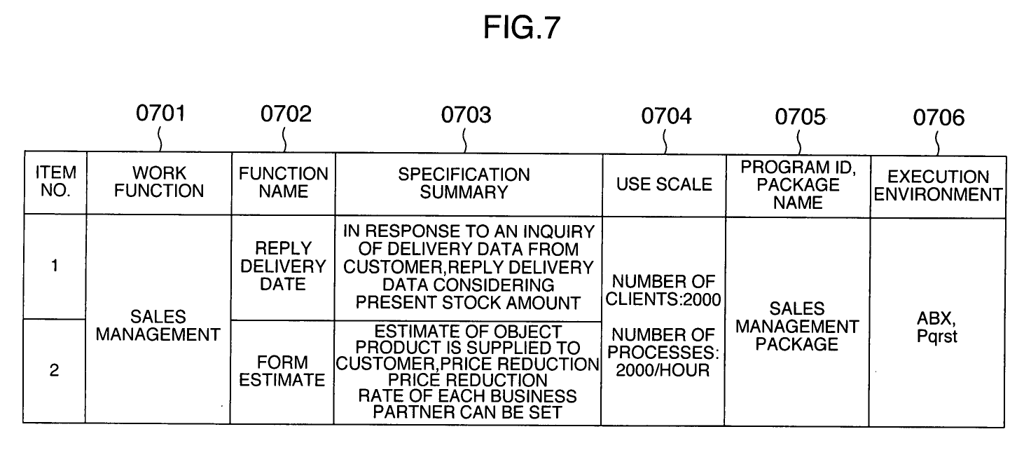

FIG. 7 shows an example of a storage layout of the system configuration example storage apparatus 0410 shown in FIG. 4. As described earlier, the system configuration example storage apparatus 0410 stores: (1) work package specifications and system configuration examples supplied from the work package supply system (work package vendor) 0203; (2) service contents and system configuration examples supplied from the service supply system (application service provider API)) 0204; (3) software component specifications or link components for linking work systems and system configuration examples supplied from the software components supply system (software component vendor or system integrator (SI)) 0205; and (4) system configuration examples configured by the order reception system 0202 in the past. The specifications and system configuration examples stored in the system configuration example storage apparatus 0410 include a work function name 0701, a function name 0702, a specification summary 0703, a program ID and work package name 0705 and an execution environment 0706, respectively registered from the specification information, and a use scale 0704 registered from the system configuration examples.

FIG. 8 is a flow chart illustrating a process of registering system configuration examples in the system configuration example storage apparatus 0410, to be executed by the order reception system 0202. First, the order reception system receives the work package specifications and system configuration examples, the service contents and system configuration examples and the work software component specifications and system configuration examples and the like from the configuration example storage input/output apparatus 0409 and configuration example input/output apparatuses 0420, 0421 and 0422 (Step 0801). Next, the order reception system 0202 performs a registration process by using the received system configuration examples (Step 0802). It is judged whether the information received at Step 0801 includes the specifications and system configuration examples similar to the contents already registered in the system configuration example storage apparatus 0410 (Step 0803). If similar specifications and configuration examples do not exist or even similar specifications and configuration examples are registered as different specifications and system configuration examples, the order reception system 0202 stores this information in the system configuration example storage apparatus 0410 (Step 0804). It is necessary to register this information as different system configuration examples, because there is a case wherein one configuration example is created by work packages and the other configuration example is created by work software components. If it is judged at Step 0803 that there are similar specifications and system configuration examples, these specifications and configuration examples are not registered in the system configuration example storage apparatus 0410.

FIG. 9 shows an example of a display screen on which the target system selection input/output apparatus 0131 displays information stored in the legacy work system analysis information storage apparatus 0408 and system configuration example storage apparatus 0410 and managed by the target system selection apparatus 0130. Referring to FIG. 9, by using a work function name 0901 and a function name 0902, there are displayed a program ID and work package name 0904, a use scale 0906 and an execution environment 0907 stored in the legacy work system analysis information storage apparatus 0408 and system configuration example storage apparatus 0410. A core flag 0903 with a circle symbol indicates that the information is presented as the requested specification by the order system 0201 and stored not in the system configuration example storage apparatus 0410 but in the legacy work system analysis information storage apparatus 0408. A specification summary 0905 is displayed because it is necessary for selecting a new work system, although it does not exist in the legacy work system analysis information storage apparatus 0408. The information (table) shown in FIG. 9 may be stored either in the target system selection apparatus 130 or in another storage (not shown) of the order reception system 0202.

In the display screen (screen displayed on the target system selection input/output apparatus 0131) shown in FIG. 9, an operator selects a work system by using a check box 0908 in accordance with the requested specification by the order system 0201. As a legacy work system is selected by using the check box 0908, the target system selection apparatus 0130 generates resources and design documents which realize the legacy work system resources or configuration examples. In this manner, the order reception system 0202 can supply the order system 0201 with a new business system.

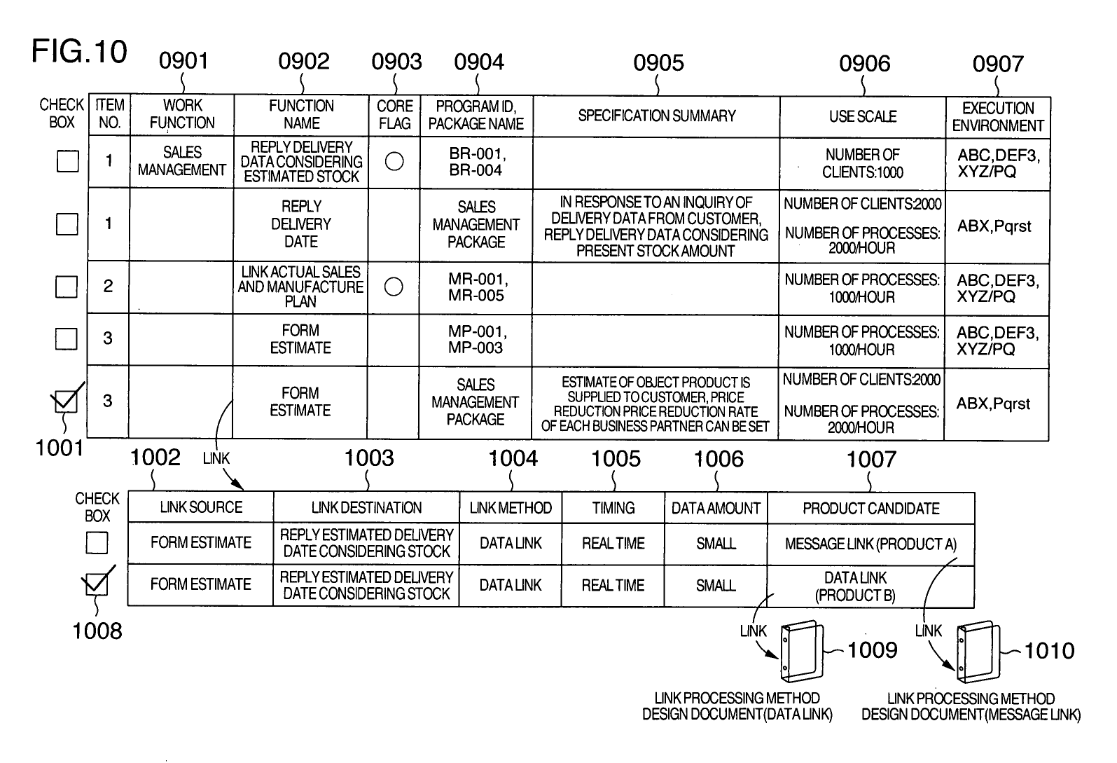

FIG. 10 shows an example of a display screen for selecting the information shown in FIG. 9 at the target system selection input/output apparatus 0131 and selecting a link processing method necessary for a link process between work systems. The upper half of FIG. 10 is the same as that shown in FIG. 9. A business system satisfying the requirements of a customer can be configured by realizing a link among a plurality of work systems selected by using a check box 1001. The example shown in FIG. 10 illustrates a process of, when a sales management system replies an estimate after the estimate is formed, replying an estimate while considering stock.

The process sequence of such a work system is almost decisive independent from enterprises, and the process sequence of a link between systems is accumulated in the system configuration example storage apparatus 0410 as system configuration examples. Displayed in accordance with the information stored in the system configuration example storage apparatus 0410 are a link source 1002, a link destination 1003, a link method 1004, a link timing 1005, a linked data amount 1006 and a product candidate 1007. The example shown in FIG. 10 indicates that an “estimate forming process” at the link source 1002 is linked to an “estimated delivery date reply process considering stock” at the link destination 1003 in “real time” at the link timing 1005 by “data link” at the link method 1004 with “small amount” at the data amount 1006.

In accordance with the example stored in the system configuration example storage apparatus 0410, a product candidate 1007 used by the corresponding link method, data amount, timing and the like is displayed. An operator selects one of selection candidates of the link method matching the requirements of the order system 0201 by using a check box 1008. In accordance with a plurality of work systems selected by using the check box 1001 and the inter-system link method selected by the check box 1008, the order reception system 0102 can output system resources (program, execution environment definition, etc.) stored in the legacy work system analysis information storage apparatus 0408, the requirements of new work systems stored in the system configuration example storage apparatus 0410, and the link method for work systems, as a new customer business system. The selection results shown in FIG. 10 are output from the target system selection apparatus 0130 as documents 1009 and 1010 collecting the work specifications and link specifications.

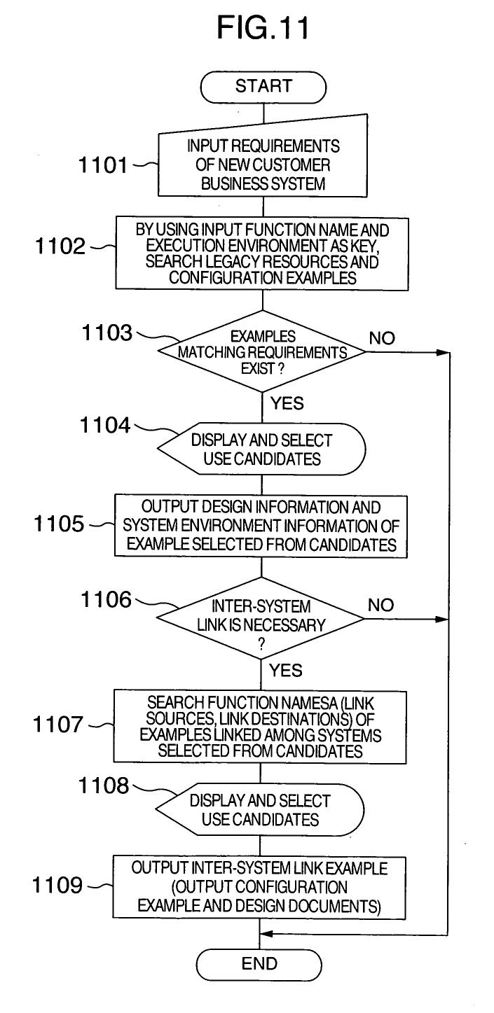

FIG. 11 is flow chart illustrating the details of a process of selecting a link method of realizing a link among work systems of a target system selected by the target system selection input/output apparatus 0131.

First, the target system selection input/output apparatus 0131 receives an input of the customer requirements of a new business system (Step 1101). Next, in accordance with the requirements input at Step 1101 (specifically, a function name and the like), the target system selection apparatus 0130 searches legacy resources and system configuration examples stored in the table shown in FIG. 9 (if information is stored in the target system selection apparatus 0130, this table) (Step 1102). If the core flag is set to the legacy custom business system in the searched table, the legacy system with the set core flag is searched with the priority over others. Next, the target system selection apparatus 0130 judges whether the examples matching the requirements input at Step 1101 are contained in the table shown in FIG. 10 (step 1103), and if the matched examples are contained, the target system selection input/output apparatus 0131 displays the examples in a use target example candidate list (Step 1104). An operator selects the use target by using the check box 0908 from the use target example candidates displayed on the target system selection input/output apparatus 0131.

Next, the target system selection apparatus 0130 extracts and outputs the design information of legacy custom work system resources, system configuration examples, and system execution environments, respectively corresponding to the work systems selected from the example candidates displayed at Step 1104 (Step 1105), and further judges whether the inter-system link is necessary among the selected systems, by referring to the information (design information of work systems and link information) stored in the system configuration storage apparatus 0410 Step 1106). If the inter-system link is necessary, the target system selection apparatus 0130 searches, from the system configuration example storage apparatus 0410, the link sources 1002, link destinations 1003, link methods 1004, timings 1005, data amounts 1006 and product candidates (items shown in FIG. 10) 1007, respectively corresponding to the link among the selected work systems (Step 1107). There is a case wherein a plurality of link examples exist for the inter-system link processes. The target system selection input/output apparatus 0131 displays link candidates (Step 1108). The operator selects target link processes from the use target candidates displayed on the target system selection input/output apparatus 412, by using the check box 1008. Lastly, the work inter-system link specification is output as an inter-system link example (Step 1109). The target system selection apparatus 0130 may use the output link example as a design document.

If there is no example matching the requirements as Step 1103 or there is no inter-system link at Step 1106, the process is terminated.

As described above, according to the embodiment, it is possible to configure a business system and realize work systems satisfying the requirements on the side of the order system 0201, by reusing work systems as core competence of the legacy customer work system stored in the legacy work system analysis information storage apparatus 0408 and creating insufficient functions by using system configuration examples stored in the system configuration example storage apparatus 0410. Further, work systems are linked by a link processing method realized by using system link examples managed by the system configuration example storage apparatus 0410. It is therefore possible to integrate individual work systems and configure a business system satisfying the requirements on the side of the order system 0201.

In developing a new business system, the analysis results of the specifications of legacy business systems are stored, and in response to an access from a system engineer to the target system selection apparatus, the specifications and execution environments of the legacy work systems can be selected. For the requirements not satisfied by the legacy work systems, proper examples are searched from the system configuration example storage apparatus storing system configuration examples, and software components and work packages are selected so that work systems can be selected. Accordingly, it is possible for a system engineer to efficiently configure a custom business system integrating respective work systems.

When a system engineer configures a custom business system by linking work systems and selects the business system from the target system selection apparatus, the system engineer refers to system design know-how information and system configuration example information integrating the number of processes and reliability and stored in the system configuration example storage apparatus. It is therefore possible to design the link processing method for work systems of the customer business system, with a smaller number of processes than that of conventional processes.

Documents and performance design of usually executed processes are made by a system engineer in configuring a business system satisfying customer requirements. In this case, the quality can be improved and a design work load can be reduced, by referring to the system configuration examples accumulating system scales and processing design.

As described so far, according to the present invention, a business system can be developed efficiently by positively utilizing legacy customer system resources.

It should be further understood by those skilled in the art that although the foregoing description has been made on embodiments of the invention, the invention is not limited thereto and various changes and modifications may be made without departing from the spirit of the invention and the scope of the appended claims.

1. A business system development supporting system for supporting a customer business system comprising:
a legacy system analysis apparatus for analyzing legacy system resources which are to be replaced with corresponding resources, the legacy system resources having been used;
a legacy system analysis information storage apparatus for storing analysis information on the legacy system resources analyzed by the legacy system analysis apparatus;
a system configuration example storage apparatus for storing system configuration examples which have been already configured in the customer business system, the examples having been already accumulated in the legacy system analysis information storage apparatus; and
a system target selection apparatus for searching work systems constituting a business system satisfying a requested specification from the customer business system in accordance with information stored in both the legacy system analysis information storage apparatus and the system configuration example storage apparatus, the system target selection apparatus comparing data prepared by the legacy system analysis information storage apparatus and data stored in said system configuration example storage apparatus.

2. The business system development supporting system according to claim 1, wherein said system configuration example storage apparatus stores a work package specification transmitted from a work package supply system connected to said order reception system, a work service specification transmitted from a work service supply system connected to said order reception system, and a software component specification transmitted from a software component supply system connected to said order reception system.

3. The business system development supporting system according to claim 1, wherein when a plurality of work systems contained in a business system to be developed are linked in accordance with information extracted from said legacy system analysis information storage apparatus and said system configuration example storage apparatus, said system target selection apparatus searches information on link.

4. The business system development supporting system according to claim 3, wherein the information on link among the plurality of work systems includes a link source, a link destination, a link method and a link timing.

5. The business system development supporting system according to claim 1, wherein said system target selection apparatus transmits a business system configured in accordance with work systems selected from said searched work systems and the information on link among said selected work systems.

6. The business system development supporting system according to claim 1, wherein information on a legacy system in said legacy system analysis information storage apparatus includes a work function on said legacy system, a function name of said work function, and information representative of whether said work function is core competence of said legacy system.

7. A business system development supporting method for a business system development supporting system of a customer business system comprising the steps of:
analyzing legacy system resources which are to be replaced with corresponding resources at a legacy system analysis apparatus, the legacy system resources having been used;
storing analysis information on said analyzed legacy system resources, in a legacy system analysis information storage apparatus;
storing system configuration examples which have been already configured, the examples having been accumulated; and
searching work systems constituting a business system satisfying a requested specification from said customer business system by a system target selection apparatus in accordance with information stored in both the legacy system analysis information storage apparatus and the system configuration example storage apparatus.
